(19) United States
(12) Patent Application Publication
(10) Pub. No.: US 2025/0378044 A1
(43) Pub. Date: Dec. 11, 2025

(54) TERMINAL DEVICE, METHOD AND APPARATUS FOR PROCESSING DATA BASED ON MODEL, AND STORAGE MEDIUM

(71) Applicant: Beijing Zitiao Network Technology Co., Ltd., Beijing (CN)

(72) Inventor: Peng DU, Beijing (CN)

(21) Appl. No.: 19/184,604

(22) Filed: Apr. 21, 2025

(30) Foreign Application Priority Data
Jun. 11, 2024 (CN) 202410749437.9

(51) Int. Cl. G06F 15/78; G06F 13/40

(52) U.S. Cl. CPC G06F 15/7821; G06F 13/4022

(57) ABSTRACT

Examples of the disclosure relate to a terminal device, a method and apparatus for processing data based on a model, and a storage medium. The terminal device includes: a first processor, a second processor and a target memory that are communicatively connected; where the first processor is configured to execute a first function; the second processor is a computing-in-memory processor, and is configured to perform data communication with the first processor and execute a second function based on data obtained from communication, the second function is a data processing function based on the model, and the second function is different from the first function; and the target memory is configured to perform data communication with the second processor and store data obtained by running the second processor.

### CROSS-REFERENCE TO RELATED APPLICATION

This application claims priority to Chinese Application No. 202410749437.9 filed on Jun. 11, 2024, the disclosure of which is incorporated herein by reference in its entirety.

### FIELD

The disclosure relates to the technical field of computers, in particular to a terminal device, a method and apparatus for processing data based on a model, and a storage medium.

### BACKGROUND

With the rise of generative models, an increasing number of portable terminal devices (such as mobile phones and tablet personal computers) have a demand to run the generative models.

### SUMMARY

Examples of the disclosure provide a terminal device, a method and apparatus for processing data based on a model, and a storage medium.

In a first aspect, the examples of the disclosure provide a terminal device. The terminal device includes: a first processor, a second processor and a target memory that are communicatively connected; where
the first processor is configured to execute a first function;
the second processor is a computing-in-memory processor, and is configured to perform data communication with the first processor and execute a second function based on data obtained from communication, the second function is a data processing function based on a model, and the second function is different from the first function; and
the target memory is configured to perform data communication with the second processor and store data obtained by running the second processor.

In a second aspect, the examples of the disclosure further provide a method for processing data based on a model. The method is applied to a second processor that executes a second function, the second function being a data processing function based on a model, and the second processor being a computing-in-memory processor; where
the method includes:
receiving a model processing instruction sent by a first processor; where the first processor is configured to execute a first function, and the first function is different from the second function;
reading model startup data from a target memory based on the model processing instruction;
running a generative model based on the model processing instruction and the model startup data, to execute the second function, and generate a model output result; and
sending the model output result to the first processor.

In a third aspect, the examples of the disclosure further provide an apparatus for processing data based on a model. The apparatus is applied to a second processor that executes a second function, the second function being a data processing function based on the model, and the second processor being a computing-in-memory processor; where the apparatus includes:
a model processing instruction receiving module configured to receive a model processing instruction sent by a first processor; where the first processor is configured to execute a first function, and the first function is different from the second function;
a model startup data reading module configured to read model startup data from a target memory based on the model processing instruction;
a model output result generating module configured to run a generative model based on the model processing instruction and the model startup data, to execute the second function, and generate a model output result; and
a model output result sending module configured to send the model output result to the first processor.

In a fourth aspect, the examples of the disclosure further provide a computer-readable storage medium. The storage medium stores a computer program, where the computer program causes a processor to implement the method for processing data based on a model according to any example of the disclosure when executed by the processor.

In a fifth aspect, the examples of the disclosure further provide a computer program product. The computer program product is configured to execute the method for processing data based on a model according to any example of the disclosure.

### BRIEF DESCRIPTION OF THE DRAWINGS

The above and other features, advantages and aspects of examples of the disclosure will become more apparent in conjunction with accompanying drawings and with reference to the following specific embodiments. Throughout the accompanying drawings, the same or similar reference numerals indicate the same or similar elements. It should be understood that the accompanying drawings are illustrative and parts and elements are not necessarily drawn to scale.

FIG. 1 is a schematic structural diagram of a terminal device according to an example of the disclosure;

FIG. 2 is a schematic diagram of a data flow of a terminal device according to an example of the disclosure, in which a memory is not directly mounted to a second processor;

FIG. 3 is a schematic structural diagram of another terminal device according to an example of the disclosure;

FIG. 4 is a schematic structural diagram of yet another terminal device according to an example of the disclosure;

FIG. 5 is a schematic diagram of a data flow of a terminal device according to an example of the disclosure, in which memories are directly mounted to two processors;

FIG. 6 is a schematic structural diagram of a terminal device according to an example of the disclosure, in which a bus switch is embedded in a first processor;

FIG. 7 is a schematic structural diagram of a terminal device according to an example of the disclosure, in which a bus switch is embedded in a second processor;

FIG. 8 is a schematic structural diagram of a terminal device according to an example of the disclosure, in which a bus switch is embedded in a target memory;

FIG. 9 is a schematic structural diagram of still another terminal device according to an example of the disclosure;

FIG. 10 is a schematic flowchart of a method for processing data based on a model according to an example of the disclosure; and

FIG. 11 is a schematic structural diagram of an apparatus for processing data based on a model according to an example of the disclosure.

### DETAILED DESCRIPTION OF EMBODIMENTS

The examples of the disclosure will be described below in more detail with reference to the accompanying drawings. Although some examples of the disclosure are shown in the accompanying drawings, it should be understood that the disclosure can be implemented through various forms and should not be constructed to be limited to the examples expounded herein. On the contrary, these examples are provided for more thorough and complete understanding of the disclosure. It should be understood that the accompanying drawings and the examples of the disclosure are merely used for illustration rather than limitation to the protection scope of the disclosure.

It should be understood that steps described in a method embodiment of the disclosure can be executed in different orders and/or in parallel. Further, the method embodiment can include an additional step and/or omit a shown step, which does not limit the protection scope of the disclosure.

As used herein, the terms “comprise”, “include” and their variations are open-ended, that is, “comprise but not limited to” and “include but not limited to”. The term “based on” indicates “at least partially based on”. The term “an example” indicates “at least one example”. The term “another example” indicates “at least another one example”. The term “some examples” indicates “at least some examples”. Related definitions of other terms will be given in the following description.

It should be noted that concepts such as “first” and “second” mentioned in the disclosure are merely used to distinguish different apparatuses, modules or units, rather than limit an order or interdependence of functions executed by these apparatuses, modules or units.

It should be noted that modifications with “a”, “an” and “a plurality of” mentioned in the disclosure are illustrative rather than limitative, and should be understood by those skilled in the art as “one or more” unless otherwise definitely indicated in the context.

A name of a message or information exchanged among a plurality of apparatuses in the embodiment of the disclosure is merely used for illustration rather than limitation to the scope of the message or information.

In order to improve a model effect, a model scale of a generative model is large. For example, when a FP16 encoding method is used, model sizes of generative models with 7 billion parameters, 1.3 billion parameters, 3.3 billion parameters and 6.5 billion parameters are 13 GB, 24 GB, 60 GB and 120 GB respectively. If some terminal devices (such as portable terminal devices) with small internal hardware assembly spaces want to run these generative models, the terminal devices need to have corresponding data storage spaces and memory bandwidths. At present, the memory bandwidth is a main factor that restricts running of the generative model by the portable terminal device.

For example, for a random access memory (RAM) equipped on a high-specification portable terminal device, a highest data transmission rate is 9600 Mbps, and a maximum total bandwidth of 4 channels with 16 bits is 76.8 GB/s. When the generative model with 7 billion parameters is run, a maximum running speed is 76.8/13=5.9 tokens/s, that is, the generative model can be computed 5.9 times within one second, without considering computing power of a neural network processing unit (NPU). If a utilization rate of the memory bandwidth is considered, the maximum running speed of the model can merely reach about 2 tokens/s-3 tokens/s. The running speed of this model is not high enough to satisfy an application requirement obviously.

The model running speed of the generative model can be increased by increasing the memory bandwidth. For example, a memory frequency and an input/output (I/O) number can be increased. However, due to an upper limit, a manufacturing process, etc. of a motherboard, increase ranges of the memory frequency and the I/O number are limited, and the model running speed cannot be significantly increased accordingly.

In view of that, the example of the disclosure provides a solution for data processing based on a model. Through the solution, a new hardware system architecture is provided, and a computing-in-memory model processor externally mounted to a main processor and a directly-mounted non-volatile memory are added to the terminal device. According to the terminal device, the method and apparatus for processing data based on a model, and the storage medium of the examples of the disclosure, a hardware system architecture of the terminal device including the first processor for executing a general function, the additional second processor having a computing-in-memory structure and a target memory corresponding to the second processor can be provided. Thus, the second processor runs the generative model having a large model scale, various data during model running are efficiently read and written through the target memory corresponding to the second processor, and high data processing and data reading capacities are provided for running the generative model accordingly. The problem that a terminal device cannot run the generative model efficiently due to restriction from a memory bandwidth is solved, and a model running speed at which the terminal device runs the generative model having the large scale is increased.

The terminal device according to the example of the disclosure may be a terminal device having a small internal hardware assembly space, such as a portable terminal device or an auxiliary device having an intelligent control function. The terminal device may be, for example, a smart phone, a personal digital assistant (PDA), a tablet personal computer (Tablet PC), a vehicle-mounted terminal (such as a vehicle-mounted navigation terminal), a digital television and a smart home device.

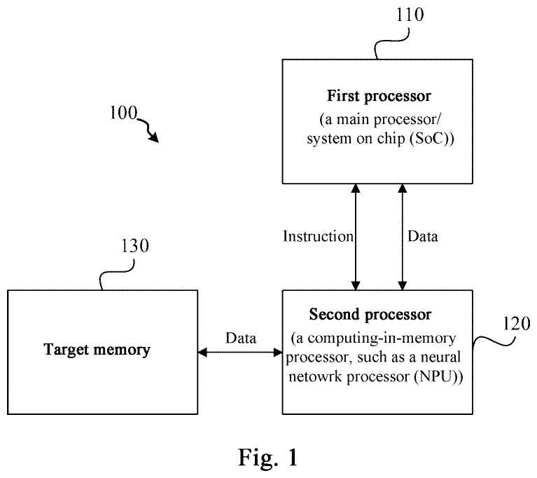

FIG. 1 shows a schematic structural diagram of a terminal device according to an example of the disclosure. As shown in FIG. 1, the terminal device 100 may include a first processor 110, a second processor 120 and a target memory 130 that are communicatively connected; where:

The first processor 110 may be an integrated circuit chip integrating many apparatuses for processing data, such as a system on chip (SoC). The first processor 110 may alternatively be an independent computing processor, such as a central processing unit (CPU), a graphics processing unit (GPU) and a neural network processor (NPU). The first processor 110 is at least configured to execute a first function. The first function by the first processor 110 is a function corresponding to the first processor 110, and may be an operating system function or an application function of a third-party application. For example, the first function is an image processing function, a display function, a sensor control function, an audio control function, a camera control function and a message broadcasting function.

The second processor 120 is a processor having a computing-in-memory architecture, which is, a storage function of temporary data and a computation function are integrated. The second processor 120 is at least configured to perform data communication with the first processor 110 and execute a second function based on data obtained from communication. This second function is a data processing function based on the generative model, that is, the second processor 120 may be configured to run the generative model. The second function herein is different from the first function. Even if the first function is a data processing function based on a model, a model run by the first function has a different specification. For example, the first function is a model function for a model having a smaller specification (such as hundreds of megabytes), while the second model is a model function for a model having a much larger specification (such as at least 10 GB).

The target memory 130 may be a non-volatile memory, such as a flash memory, an electrically erasable and rewritable read only memory (ROM) and an optically erasable and rewritable ROM. The target memory is at least configured to perform data communication with the second processor 120, and store data that are obtained by running the second processor 120 and need to be output and stored.

In the terminal device 100, the second processor 120 is designed in a computing-in-memory structure. Thus, in a process of running the generative model, the second processor can reduce reading, writing and transporting of temporary data with another non-volatile memory, and performance and efficiency of running the generative model by the second processor 120 are improved to some extent.

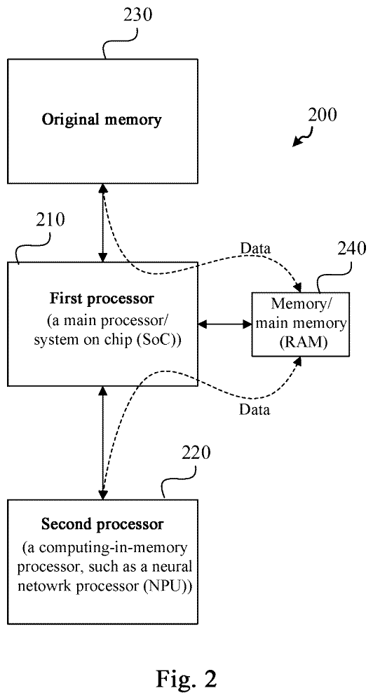

In addition, the second processor 120 may at least directly perform data communication with the target memory 130, such that efficiency of reading, writing and transporting other data during model running is increased, and the performance and the efficiency of running the generative model by the second processor 120 are further improved. Reference can be made to FIG. 2 for an explanation of this process. If the second processor 220 is not directly docked with a non-volatile original memory of the system, that is, an original memory 230, the second processor needs to read data required by the model from the original memory 230 under the control by the first processor 210 (such as the CPU) in the process of running the generative model. Then, the data are transmitted to the second processor 220 by a communication interface between the first processor 210 and the second processor 220 through a memory 240 (a directly addressable volatile memory such as the RAM) of the first processor 210. Such a data transfer path is long, and needs to occupy resources such as the CPU and the RAM of the first processor 210, resulting in very low data reading and writing efficiency. In view of that, in the example of the disclosure, the second processor 120 in the terminal device 100 is directly docked with the target memory 130.

In some examples, a data interaction process of the terminal device 100 may be implemented as follows:
the second processor 120 receives a model processing instruction sent by the first processor 110;
the second processor 120 reads model startup data from the target memory 130 based on the model processing instruction;
the second processor 120 runs a generative model based on the model processing instruction and the model startup data, to execute the second function, and generate a model output result; and
the second processor 120 sends the model output result to the first processor 110.

Reference can be made to the detailed description of subsequent method examples for explanation of terms and steps involved in the data interaction process.

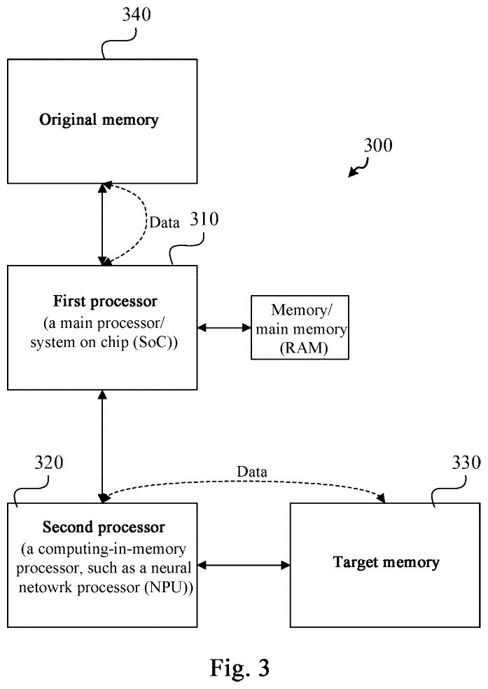

In some examples, memories may be mounted to both the first processor 110 and the second processor 120 separately. With reference to FIG. 3, a terminal device 300 includes at least a first processor 310 and an original memory 340 corresponding to the first processor, and a second processor 320 and a target memory 330 corresponding to the second processor. In this way, when the first processor 310 executes the first function, the first processor may directly read and write data from the original memory 340, such that execution efficiency of the first function is high. When the second processor 320 executes the second function based on the model, the second processor can directly read and write data from the target memory 330, such that efficient reading and writing of the data required by the model running can be guaranteed and efficiency of running the generative model is increased.

According to the terminal device of the example of the disclosure, a hardware system architecture including the first processor for executing a general function, the additional second processor having the computing-in-memory structure and the target memory corresponding to the second processor can be provided. Thus, the second processor runs the generative model having a large model scale, various data during model running are efficiently read and written through the target memory corresponding to the second processor, and high data processing and data reading capacities are provided for running the generative model accordingly. The problem that a terminal device cannot run the generative model efficiently due to restriction from a memory bandwidth is solved, and a model running speed at which the terminal device runs the generative model having the large scale is increased.

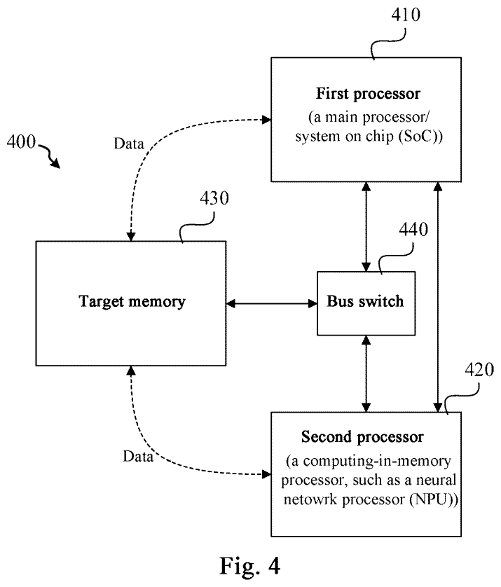

In some examples, with reference to FIG. 4, a target memory 430 in a terminal device 400 is further configured to perform data communication with a first processor 410 and store data obtained by running the first processor 410. In addition, the terminal device 400 further includes a bus switch 440, and the bus switch 440 is communicatively connected to the first processor 410, a second processor 420 and the target memory 430 and is configured to switch the target memory 430 to perform the data communication with the first processor 410 or switch the target memory 430 to perform the data communication with the second processor 420.

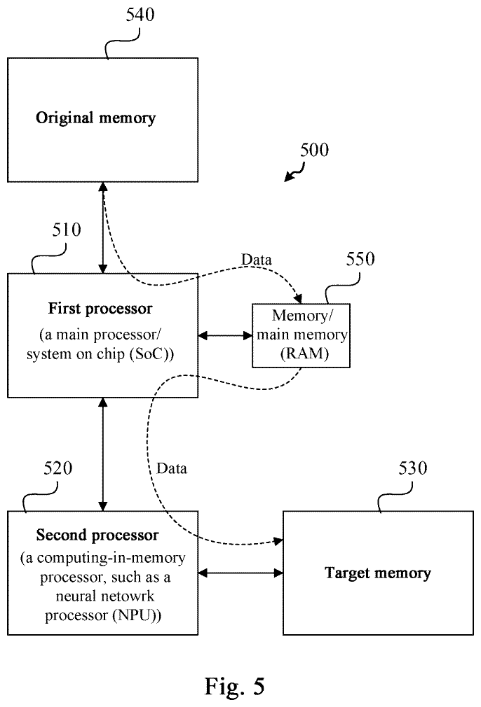

In these examples, the first processor 410 and the second processor 420 share the target memory 430, and the target memory 430 is switched, through the bus switch 440, to perform the data communication with the first processor 410 or the second processor 420. For this setting, one reason is that waste of memory resources and an increase in hardware cost are likely to be caused, and another reason is low efficiency of data processing during data interaction between two memories with this process to be described with reference to FIG. 5.

With reference to FIG. 5, an original memory 540 and a target memory 530 are mounted to a first processor 510 and a second processor 520 respectively. In this case, although respective function execution efficiency of the two processors can be increased, data interaction, if needed, between the first processor 510 and the second processor 520 has a long data flow path, and occupies resources such as a CPU and an RAM of the first processor 510, resulting in very low data reading and writing efficiency. For example, when the target memory 530 needs to obtain data from the original memory 540, the first processor 510 needs to read the data from the original processor 540, and then the data are transmitted to the second processor 520 by a communication interface between the first processor 510 and the second processor 520 through a memory 550 (a directly addressable volatile memory such as the RAM) of the first processor 510. Finally, the second processor 520 writes the data to the target memory 530.

Based on the description, in this example, the two processors are arranged to share the target memory 430, and data communication objects of the target memory 430 are switched through the bus switch 440. In this way, hardware cost of the memory can be reduced, a resource utilization rate of the target memory 430 can be increased, interaction efficiency of stored data corresponding to the two memories can be increased, and efficiency of running of the generative model by the terminal device can be further increased.

In some examples, in order to reduce an internal hardware mounting space of the terminal device, the bus switch may be integrated into the first processor, the second processor or the target memory.

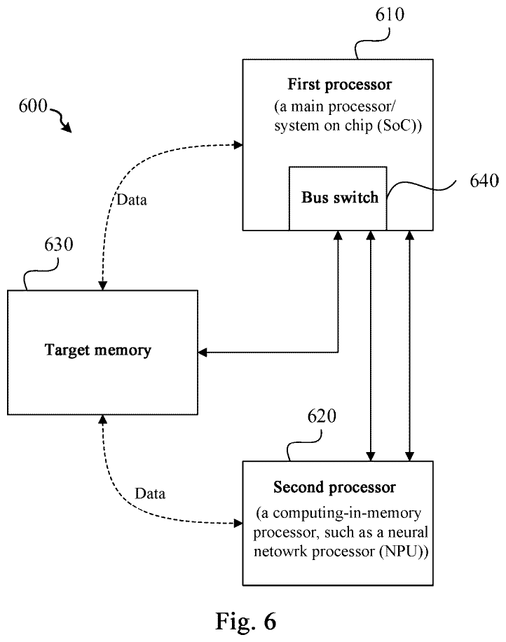

With reference to FIG. 6, a bus switch 640 in a terminal device 600 may be integrated in a first processor 610. In this way, when the first processor 610 needs to perform data communication with a target memory 630, the bus switch 640 may enable a function of data communication of the first processor 610 with the target memory 630. When a second processor 620 needs to perform data communication with the target memory 630, the bus switch 640 may enable a function of data communication of the second processor 620 with the target memory 630.

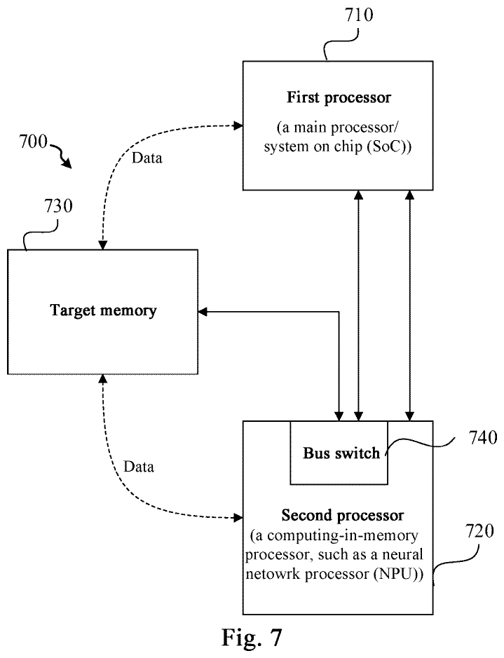

With reference to FIG. 7, a bus switch 740 in a terminal device 700 may be integrated in a second processor 720. In this way, when a first processor 710 needs to perform data communication with a target memory 730, the bus switch 740 may enable a function of data communication of the first processor 710 with the target memory 730. When the second processor 720 needs to perform data communication with the target memory 730, the bus switch 740 may enable a function of data communication of the second processor 720 with the target memory 730.

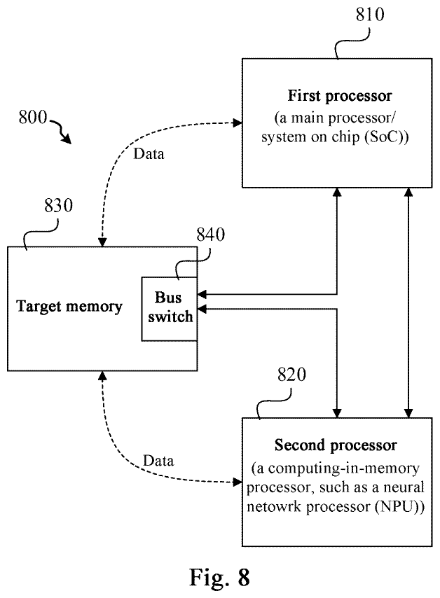

With reference to FIG. 8, a bus switch 840 in a terminal device 800 may be integrated into a target memory 830. In this way, when a first processor 810 needs to perform data communication with the target memory 830, the bus switch 840 may enable a function of data communication of the first processor 810 with the target memory 830. When a second processor 820 needs to perform data communication with the target memory 830, the bus switch 840 may enable a function of data communication of the second processor 820 with the target memory 830.

In some examples, a data interaction process of the terminal device 400 may be implemented as follows:
the second processor 420 receives a model processing instruction sent by the first processor 410;
the second processor 420 reads model startup data from the target memory 430 based on the model processing instruction in response to determining that a function of the data communication with the target memory 430 is enabled;
the second processor 420 runs a generative model based on the model processing instruction and the model startup data, to execute a second function, and generate a model output result; and
the second processor 420 sends the model output result to the first processor 410.

Further, the second processor 420 switches a communication switch of the target memory 430 through the bus switch 440 in response to determining that the function of the data communication with the target memory 430 is disabled, and enables the function of the communication of the second processor 420 with the target memory 430.

Similarly, reference can be made to the detailed description of subsequent method examples for explanation of terms and steps involved in the data interaction process.

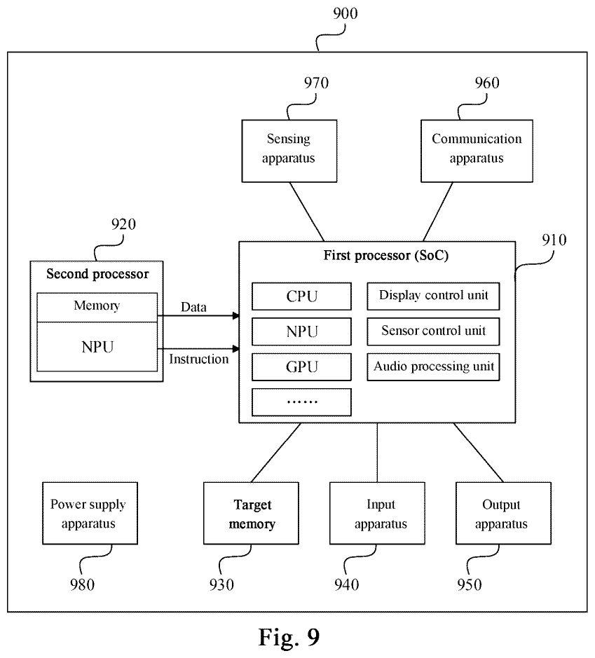

FIG. 9 shows a schematic structural diagram of still another terminal device according to an example of the disclosure.

As shown in FIG. 9, the terminal device 900 includes a first processor 910, a second processor 920 and a target memory 930, and may further include an input apparatus 940, an output apparatus 950, a communication apparatus 960, a sensing apparatus 970 and a power supply apparatus 980, and these components may be communicatively connected through a bus.

Reference can be made to the relevant descriptions of the above examples for descriptions of the first processor 910, the second processor 920 and the target memory 930. In addition, the first processor 910 may further include corresponding control units for controlling the above apparatuses, such as a display control unit, an audio control unit and a sensor control unit. In addition, the first processor 910 and the second processor 920 may execute various appropriate actions and processes according to programs stored in their corresponding target memories 930 or programs loaded into the corresponding memories from an external storage apparatus (such as a magnetic tape and a mechanical hard disk). Various programs and data required for an operation by the terminal device 900 are further stored in the target memory 930.

The input apparatus 940 may include, but is not limited to, a touch screen, a touch pad, a keyboard, a mouse and a microphone. The output apparatus 950 may include, but is not limited to, a display, a speaker and a vibrator. The sensing apparatus 970 may include, but is not limited to, a camera, an accelerometer, a positioning sensor and a gyroscope.

The communication apparatus 960 may allow the terminal device 900 to be in wireless or wired communication with other devices for data exchange. The power supply apparatus 980 energizes various components.

It should be noted that the terminal device 900 shown in FIG. 9 is merely an instance, and should not be constructed as limitation to functions and use scopes of the examples of the disclosure. Although the terminal device 900 having various apparatuses is shown in FIG. 9, it should be understood that all the apparatuses shown are not required to be implemented or provided. More or fewer apparatuses may be alternatively implemented or provided.

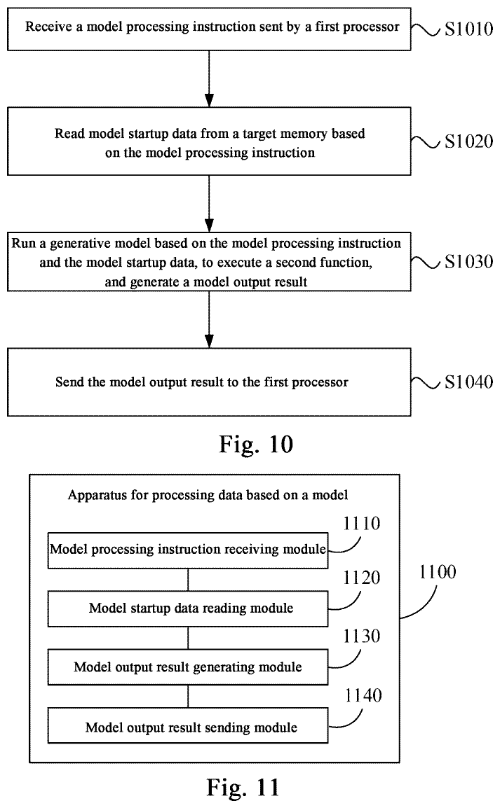

FIG. 10 shows a schematic flowchart of a method for processing data based on a model according to an example of the disclosure. The method for processing data based on a model according to the example of the disclosure may be executed by an apparatus for processing data based on a model. The apparatus may be implemented by software and/or hardware. The apparatus may be integrated into a terminal device having a small internal hardware assembly space, such as a portable terminal device or an auxiliary device having an intelligent control function. The method for processing data based on a model may be specifically executed by a second processor in the terminal device.

As shown in FIG. 10, the method for processing data based on a model may include:

S1010, a model processing instruction sent by a first processor is received.

The first processor is configured to execute a first function, and the first function is different from a second function. The model processing instruction is an instruction to trigger running of a generative model. The model processing instruction may be an instruction generated after a user inputs related content or an instruction generated after the user triggers a related control. An instruction content of the model processing instruction may be determined according to an external invoking interface of the generative model. For example, the external invoking interface of the generative model needs the user to input some specific contents (such as a text, an image or a video), the model processing instruction may include the specific contents input by the user. If the external invoking interface of the generative model does not need the specific contents input by the user, the model processing instruction does not include the specific contents input by the user.

Specifically, the terminal device may provide the user with an invoking interaction entry of the generative model, such as an application, a webpage and an applet, of the generative model. If the user wants to run the generative model, the user may execute a corresponding invoking operation through the invoking interaction entry. For example, the user may input his/her demand contents in the form of a voice, a text or a rich text, and trigger a control for model running. Alternatively, the user may directly trigger the control for model running by taking a default/automatic matching invoking startup content corresponding to the generative model as the demand content of the user. In this way, the first processor in the terminal device may receive the model processing instruction generated based on the demand content and the triggering operation of the control Then, the first processor sends a target processing instruction to the second processor through a control interface between the first processor and the second processor. Then, the second processor may receive the model processing instruction sent by the first processor.

S1020, model startup data are read from a target memory based on the model processing instruction.

The model startup data refer to input data indispensable for running the generative model, and specifically refer to model input data except the demand content of the user included in the model processing instruction. For example, the model startup data may be model parameters obtained from a training stage, a model prompt text (prompt), and other auxiliary data.

Specifically, in order to simplify an operation process of using the generative model by the user, the input content/the demand content of the user into the invoking interaction entry may be set as simplified as possible. Model input data required for model startup without personalized determination by the user are stored in the target memory and associated with the model processing instruction. In this way, after the second processor receives the model processing instruction, the second processor may search through the target memory according to the model processing instruction and read the model startup data obtained through searching.

S1030, the generative model is run based on the model processing instruction and the model startup data, the second function is executed, and a model output result is generated.

Specifically, the second processor takes the demand content and the model startup data included in the model processing instruction as the input data of the generative model, and invokes the generative model for data computation. A running process of the generative model is a process of executing the second function. After the computation by the model is completed, the model may obtain computation data, that is, the model output result.

S1040, the model output result is sent to the first processor.

Specifically, the second processor transmits the model output result to the first processor via a communication interface such as peripheral component interface express (PCIE). Then, the first processor may continue to execute processing logic of the first processor according to the model output result. For example, the first processor may continue to complete a subsequent processing logic of the first function by using the model output result. Alternatively, the first processor may display the model output result in a corresponding display mode (such as the voice, the text, the image, a sound and a vibration) by controlling a display apparatus connected to the first processor.

In some examples, if the first processor and the second processor share the target memory, S1020 may be implemented as follows: a communication switch of the target memory is switched through a bus switch in response to determining that a function of data communication with the target memory is disabled, and the function of the communication of the second processor with the target memory is enabled. The model startup data are read from the target memory based on the model processing instruction in response to determining that a function of the data communication with the target memory is enabled.

Specifically, when determining that the function of the data communication of the target memory with the second memory is disabled, the terminal device may control the bus switch to switch a data communication channel, disable a function of data communication of the target memory with the first processor, and enable the function of the data communication of the target memory with the second memory. In this way, the terminal device can read the model startup data from the target memory according to the model processing instruction.

According to the method for processing data based on a model of the example of the disclosure, by means of the additionally added second processor having a computing-in-memory structure and the target memory corresponding to same, the model processing instruction sent by the first processor can be received, the model startup data can be efficiently read from the target memory based on the model processing instruction. Then, the generative model can be run based on the model processing instruction and the model startup data, the second function can be executed and the model output result can be generated. The model output result can be sent to the first processor. The problem that a terminal device cannot run the generative model efficiently due to restriction from a memory bandwidth is solved, a model running speed at which the terminal device runs the generative model having the large scale is increased, and corresponding execution efficiency of the second function is increased.

FIG. 11 shows a schematic structural diagram of an apparatus for processing data based on a model according to an example of the disclosure. The apparatus is configured in the second processor that has the computing-in-memory structure and executes the second function based on the model in the system for processing data based on a model. This apparatus has the same inventive concept as the method for processing data based on a model in the examples described above. Reference can be made to the examples of the method for processing data based on a model for details not described in detail in the example of the apparatus for processing data based on a model.

As shown in FIG. 11, the apparatus 1100 for processing data based on a model may include:
a model processing instruction receiving module 1110 configured to receive a model processing instruction sent by a first processor; where the first processor is configured to execute a first function, and the first function is different from the second function;
a model startup data reading module 1120 configured to read model startup data from a target memory based on the model processing instruction;
a model output result generating module 1130 configured to run a generative model based on the model processing instruction and the model startup data, to execute the second function, and generate a model output result; and
a model output result sending module 1140 configured to send the model output result to the first processor.

In some examples, the model startup data reading module 1120 is specifically configured to:
switch a communication switch of the target memory through a bus switch in response to determining that a function of data communication with the target memory is disabled, and enable a function of the communication of the second processor with the target memory; and
read the model startup data from the target memory based on the model processing instruction in response to determining that the function of the data communication with the target memory is enabled.

The apparatus for processing data based on a model according to the example of the disclosure may execute the method for processing data based on a model according to any example of the disclosure, and has corresponding functional modules and beneficial effects for executing the method.

It is worth noting that the modules included in the example in the apparatus for processing data based on a model described above are merely divided according to a functional logic, but are not limited to the above division, as long as the corresponding functions can be performed. In addition, specific names of the functional modules are merely for the convenience of mutual distinguishing rather than limitation to the protection scope of the disclosure.

Specifically, according to the example of the disclosure, a process described above with reference to the flowchart may be implemented as a computer software program. For example, the example of the disclosure includes a computer program product. The computer program product includes a computer program carried on a non-transitory computer-readable medium, and the computer program includes program codes for executing the method shown in the flowchart. In such an example, the computer program may be downloaded and installed from the network through the communication apparatus 960 as shown in FIG. 9, or installed from the target memory 930/the external memory. When executed by the second processor 920, the computer program executes the functions defined above in the method for processing data based on a model according to any example of the disclosure.

The example of the disclosure further provides a computer-readable storage medium. The storage medium stores a computer program, where the computer program causes a processor to implement the method for processing data based on a model according to any example of the disclosure when executed by the processor.

It should be noted that the computer-readable medium described above in the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or their any combination. More specific examples of the computer-readable storage medium may include, but is not limited to, an electrical connection having one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or their any suitable combination. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is carried. This propagated data signal may have a plurality of forms, including but not limited to an electromagnetic signal, an optical signal or their any suitable combination. The computer-readable signal medium may further be any computer-readable medium other than the computer-readable storage medium, and the computer-readable signal medium may send, propagate or transmit a program used by or in combination with the instruction execution system, apparatus or device. A program code included in the computer-readable medium may be transmitted by any suitable medium, including but not limited to: a wire, an optical cable, a radio frequency (RF) medium, or their any suitable combination.

In some embodiments, a client side and a server may communicate by using any currently-known or future-developed network protocol such as the hypertext transfer protocol (HTTP), and may be interconnected to digital data communication (for example, a communication network) in any form or medium. Instances of the communication network include a local area network (“LAN”), a wide area network (“WAN”), network of network (for example, the Internet), an end-to-end network (for example, ad hoc), and any currently-known or future-developed network.

The computer-readable medium may be included in the terminal device, or exist independently without being fitted into the terminal device.

The computer-readable medium carries one or more programs, and the one or more programs cause the terminal device to execute the method for processing data based on a model according to any example of the disclosure when executed by the terminal device.

In the example of the disclosure, computer program codes for executing the operations of the disclosure may be written in one or more programming languages or their combinations, and the programming languages include, but are not limited to, object-oriented programming languages such as Java, Smalltalk and C++, and further include conventional procedural programming languages such as “C” language or similar programming languages. The program codes may be completely executed on a computer of the user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including the local area network (LAN) or the wide area network (WAN), or may be connected to an external computer (for example, through the Internet provided by an Internet service provider).

The flowcharts and block diagrams in the accompanying drawings illustrate the system architectures, functions and operations that may be implemented by the devices, the methods and the computer program products according to various examples of the disclosure. In this regard, each block in the flowchart or block diagram may denote one module, one program segment, or some of codes that includes one or more executable instructions for implementing specified logical functions. It should also be noted that in some alternative implementations, the functions indicated in the blocks may occur in an order different than those indicated in the accompanying drawings. For example, two blocks indicated in succession may be actually executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The functions described above herein may be executed at least in part by one or more hardware logic components. For example, without limitation, illustrative types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. More specific instances of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or their any suitable combination.

The description above is merely about preferred examples of the disclosure and applied technical principles. It should be understood by those skilled in the art that the disclosed scope involved in the disclosure is not limited to the technical solution formed by a specific combination of the technical features described above, but further covers another technical solution formed by any random combination of the technical features described above or their equivalent features without departing from the concepts described above of the disclosure, for example, a technical solution formed by interchanging the features described above and (non-limitative) technical features having similar functions as disclosed in the disclosure.

In addition, although the operations are depicted in a particular order, it should not be understood that these operations are required to be executed in the particular order shown or in a sequential order. In certain circumstances, multi-task and parallel processing can be advantageous. Similarly, although several specific implementation details are included in the discussion described above, these details should not be construed as limitation to the scope of the disclosure. Some features described in the context of a separate example can be further implemented in a single example in a combination manner. On the contrary, various features described in the context of a single example can be further implemented in a plurality of examples separately or in any suitable sub-combination manner.

Although the subject matter has been described in a language specific to structural features and/or methodological logical actions, it should be understood that the subject matter defined in the appended claims is not necessarily limited to the specific features or actions described above. On the contrary, the specific features and actions described above are merely illustrative implementation forms of the claims.

I/We claim:

1. A terminal device, comprising: a first processor, a second processor and a target memory that are communicatively connected; wherein
the first processor is configured to execute a first function;
the second processor is a computing-in-memory processor, and is configured to perform data communication with the first processor and execute a second function based on data obtained from the communication, the second function is a data processing function based on a model, and the second function is different from the first function; and
the target memory is configured to perform data communication with the second processor and store data obtained by running the second processor.

2. The terminal device according to claim 1, wherein the target memory is further configured to perform data communication with the first processor and store data obtained by running the first processor; and
the terminal device further comprises a bus switch, and the bus switch is communicatively connected to the first processor, the second processor and the target memory, and is configured to switch the target memory to perform the data communication with the first processor or switch the target memory to perform the data communication with the second processor.

3. The terminal device according to claim 2, wherein the bus switch is integrated into the first processor, the second processor or the target memory.

4. The terminal device according to claim 1, wherein the second processor is configured to:
receive a model processing instruction sent by the first processor;
read model startup data from the target memory based on the model processing instruction;
run a generative model based on the model processing instruction and the model startup data, to execute the second function, and generate a model output result; and
send the model output result to the first processor.

5. The terminal device according to claim 2, wherein the second processor is configured to:
receive a model processing instruction sent by the first processor;
read model startup data from the target memory based on the model processing instruction in response to determining that a function of the data communication with the target memory is enabled;
run a generative model based on the model processing instruction and the model startup data, to execute the second function, and generate a model output result; and
send the model output result to the first processor.

6. The terminal device according to claim 5, wherein the second processor is further configured to:
after receiving the model processing instruction sent by the first processor, switch a communication switch of the target memory through the bus switch in response to determining that the function of the data communication with the target memory is disabled, and enable a function of communication of the second processor with the target memory.

7. A method for processing data based on a model, applied to a second processor that executes a second function, the second function being a data processing function based on the model, and the second processor being a computing-in-memory processor; wherein
the method comprises:
receiving a model processing instruction sent by a first processor, wherein the first processor is configured to execute a first function, and the first function is different from the second function;
reading model startup data from a target memory based on the model processing instruction;
running a generative model based on the model processing instruction and the model startup data, to execute the second function, and generate a model output result; and
sending the model output result to the first processor.

8. The method according to claim 7, wherein reading model startup data from the target memory based on the model processing instruction comprises:
switching a communication switch of the target memory through a bus switch in response to determining that a function of data communication with the target memory is disabled, and enabling a function of communication of the second processor with the target memory; and
reading the model startup data from the target memory based on the model processing instruction in response to determining that the function of the data communication with the target memory is enabled.

9. A non-transitory computer-readable storage medium, storing a computer program, wherein the computer program, when executed by a processor, causes the processor to:
receive a model processing instruction sent by a first processor, wherein the first processor is configured to execute a first function, and the first function is different from the second function;
read model startup data from a target memory based on the model processing instruction;
run a generative model based on the model processing instruction and the model startup data, to execute the second function, and generate a model output result; and
send the model output result to the first processor.

10. The non-transitory computer-readable storage medium of claim 9, wherein the computer program further causes the processor to:
switch a communication switch of the target memory through a bus switch in response to determining that a function of data communication with the target memory is disabled, and enable a function of communication of the second processor with the target memory.

11. The non-transitory computer-readable storage medium of claim 9, wherein the computer program further causes the processor to:
read the model startup data from the target memory based on the model processing instruction in response to determining that the function of the data communication with the target memory is enabled.

12. The non-transitory computer-readable storage medium of claim 9, wherein the first function is a function of a first model.

13. The non-transitory computer-readable storage medium of claim 12, wherein the scale of the first model is smaller than the scale of the generative model.

14. The non-transitory computer-readable storage medium of claim 12, wherein the first function is an operating system function.

15. The non-transitory computer-readable storage medium of claim 12, wherein the first function is an application function of a third-party application.

16. The non-transitory computer-readable storage medium of claim 12, wherein the first function is one of an image processing function, a display function, a sensor control function, an audio control function, a camera control function and a message broadcasting function.

17. The non-transitory computer-readable storage medium of claim 9, wherein the first processor, the second processor and the target memory are communicatively connected.

18. The non-transitory computer-readable storage medium of claim 9, wherein the second processor is a computing-in-memory processor.

19. The non-transitory computer-readable storage medium of claim 9, wherein the target memory is configured to perform data communication with the second processor and store data obtained by running the second processor.

20. The non-transitory computer-readable storage medium of claim 9, wherein the target memory is further configured to perform data communication with the first processor and store data obtained by running the first processor.
